(19) United States
(12) Patent Application Publication
(10) Pub. No.: US 2025/0222558 A1
(43) Pub. Date: Jul. 10, 2025

(54) HIGH FREQUENCY POLISHING OF CERAMICS

(71) Applicant: HERAEUS COVANTICS NORTH AMERICA LLC, Chandler, AZ (US)

(72) Inventors: Luke WALKER, Chandler, AZ (US); Matthew Joseph DONELON, Chandler, AZ (US); Saurabh WAGHMARE, Chandler, AZ (US)

(21) Appl. No.: 18/851,430

(22) PCT Filed: Mar. 24, 2023
(86) PCT No.: PCT/US2023/016275

§ 371 Date: Sep. 26, 2024

Related U.S. Application Data
(60) Provisional application No. 63/325,956, filed on Mar. 31, 2022.

(51) Int. Cl. B24B 49/04; B24B 7/22; B24B 37/04; B24B 37/12; B24B 51/00

(52) U.S. Cl. CPC B24B 49/04; B24B 7/22; B24B 37/044; B24B 37/12; B24B 51/00

(57) ABSTRACT

A method of polishing a surface of a polycrystalline sintered ceramic body, the method comprising the steps of: a) providing a sintered ceramic body comprising a polycrystalline material and having a density of from about 99.5% to about 99.999% of the polycrystalline material's theoretical density, wherein the sintered ceramic body has at least one surface; b) grinding the at least one surface until the surface has (I) a flatness of no more than 25 microns on average measured over four quadrants of the at least one surface at angles of 0°, 90°, 180°, and 270° as measured with a spherometer, (ii) an Ra of less than 14 microinches, and (iii) an Rz of less than 160 microinches; c) after the grinding step, lapping the at least one surface with a lapping plate and a lapping media slurry; d) after lapping, successively polishing the at least one surface.

### BACKGROUND OF THE INVENTION

The present invention relates to a method and apparatus for polishing dense sintered ceramic bodies to a very high degree of surface smoothness suitable for use as corrosion resistant components within semiconductor plasma processing chambers.

Semiconductor processing requires the use of halogen-based gases in combination with high electric and magnetic fields to create a plasma environment. This plasma environment is made within vacuum chambers for etching or depositing materials on semiconductor substrates. These vacuum chambers include component parts such as disks or windows, liners, injectors, rings, and cylinders. During semiconductor plasma processing, the substrates are typically supported within the vacuum chamber by substrate holders, as disclosed, for example, in U.S. Pat. Nos. 5,262,029 and 5,838,529. Process gas for creation of the plasma processing environment can be suppled to the chamber by various gas supply systems. Some processes involve use of a radio frequency (RF) field and process gases are introduced into the processing chamber while the RF field is applied to the process gases to generate a plasma of the process gases. Ceramic materials used to form these components, in particular for RF applications, are required to have low dielectric loss tangents, on the order of 1×10⁻³ and less. Dielectric losses higher than this cause overheating and hot spots within the components during use, leading to process variability and yield loss. Components fabricated from highly pure starting powders and use of manufacturing processes retaining initial purity will provide sintered ceramics to meet these low loss requirements. The harsh plasma processing environment necessitates the use of highly corrosion and erosion resistant materials for chamber components. These components have been formed from materials that provide resistance to corrosion and erosion in plasma environments and have been described, for example, in U.S. Pat. Nos. 5,798,016, 5,911,852, 6,123,791 and 6,352,611. Moreover, plasma processing chambers have been designed to include parts such as disks, rings, and cylinders that confine the plasma over the wafer being processed. However, these parts used in plasma processing chambers are continuously attacked by the plasma and consequently corrode, erode or accumulate contaminants and polymer build-up. The plasma etch and deposition conditions cause erosion and roughening of the surfaces of the chamber parts that are exposed to the plasma. This corrosion contributes to wafer level contamination through the release of particles from the component surface into the chamber, resulting in semiconductor device yield loss.

To address this, oftentimes chamber components have a surface layer which is resistant to corrosion and erosion upon exposure to the process gases. The surface layer may be formed atop a base or substrate which may have superior mechanical, electrical or other preferred properties. Corrosion resistant films or coatings of for example yttrium oxide or yttrium aluminum garnet (YAG) have been known to be deposited atop a base or substrate formed of a different material which are lower in price and higher in strength than most corrosion resistant materials. Such films or coatings have been made by several methods. Vapor deposition methods have been used to deposit corrosion resistant films on substrates, however vapor deposition is limited to relatively thin layers due to internal film stresses and often small holes are present in the thin film. These internal film stresses cause poor inter-layer adhesion and result in delamination typically at an interface between the corrosion resistant film and the base material, rendering these layers prone to cracking and spalling which thereby leads to undesirable particulate contamination. Corrosion resistant coatings or films made by aerosol or plasma spray techniques typically exhibit high levels of porosity of between 3% to about 50%, and correspondingly low density. Further, these films produced by aerosol or spray methods exhibit poor interfacial adhesion between the substrate material and the corrosion resistant layer, resulting in flaking and exfoliation and subsequent chamber contamination.

Accordingly, there exists a need for producing hard ceramic materials having highly polished surfaces with a surface roughness below about two microinches uniformly for high strength sintered ceramic bodies of large dimension (greater than 100 mm, such as, for example, from 100 mm to 625 mm) to enable fabrication of corrosion resistant semiconductor devices at a large scale.

### BRIEF SUMMARY OF THE INVENTION

Advantageously, the present disclosure provides a method for polishing the surface of a large-dimensioned sintered ceramic body to a uniform surface smoothness of from about 2 microinches to about 1.5 microinches. Disclosed herein is a method of polishing a surface of a polycrystalline sintered ceramic body, the method comprising the steps of: a) providing a sintered ceramic body comprising a polycrystalline material and having a density of from about 99.5% to about 99.999% of the polycrystalline material's theoretical density, wherein the sintered ceramic body has at least one surface; b) grinding the at least one surface until the surface has (i) a flatness of no more than 25 microns on average measured over four quadrants of the at least one surface at angles of 0°, 90°, 180°, and 270° as measured with a spherometer, (ii) an Ra of less than 14 microinches, and (iii) an Rz of less than 160 microinches; c) after the grinding step, lapping the at least one surface with a lapping plate and a lapping media slurry; d) after lapping, successively polishing the at least one surface in a series of polishing steps until the at least one surface exhibits an Ra value of ≤2 microinches and an Rz of ≤2 microinches and an absolute value for flatness of greater than 15 microns as measured with a spherometer, wherein the polishing is performed with a device comprising a plurality of orbital sanders (also called orbit sanders) that vibrate elliptically each of which comprises a polishing pad to contact the at least one surface during polishing, wherein the series of polishing steps comprises: i) a first polishing step wherein the polishing pads are used with a slurry of 4 to 10-micron grit particles; and ii) a second polishing step wherein the polishing pads are used with a slurry of from 1 to 3-micron grit particles.

In another aspect, provided herewith is a polycrystalline sintered ceramic body comprising at least 99.99% YAG and having at least one upper surface having a surface area of greater than 400 square inches, the surface having a spherometer measurement with an absolute value greater than 15 microns over four quadrants of the disk, and Ra and Rz each less than or equal to 2 microinches over the surface area, and a porosity of less than 0.045% over the surface area, wherein the sintered ceramic disk has a thickness of at least 20 mm.

In yet another aspect, provided herewith is a polishing apparatus comprising a plate comprising a plurality of orbital sanders that vibrate elliptically each of which comprises a polishing pad; and a rotatable table suitable for rotating a part to be polished, wherein the plate remains fixed during polishing while the part is rotated on the table, and wherein the orbit sanders are mounted on the plate such that the polishing pads face the rotatable table.

The embodiments of the invention can be used alone or in combinations with each other.

### BRIEF DESCRIPTION OF THE DRAWINGS

FIG. 1 is a prospective view of an embodiment disclosed herein;

FIG. 2 is a prospective view of an exemplary mounting plate;

FIG. 3 is an illustration of an embodiment of a random orbital sander for use in embodiments disclosed herein;

FIG. 4 is a prospective view of an embodiment of a housing for a random orbital sander for use in embodiments disclosed herein;

FIG. 5 is an illustration of an embodiment of a random orbital sander ready for mounting on a plate such as that of FIG. 2 in embodiments disclosed herein; and

FIG. 6 is an embodiment of an exemplary polishing apparatus for use in the disclosed method.

### DETAILED DESCRIPTION OF THE INVENTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. Various changes may be made in the function and arrangement of elements without departing from the spirit and scope of the invention, as set forth in the appended claims.

The term “about” means approximately or nearly, and in the context of a numerical value or range set forth herein in one embodiment means ±20%, ±10%, ±5%, or ±3% of the numerical value or range recited or claimed.

The terms “a” and “an” and “the” and similar reference used in the context of describing the disclosure (especially in the context of the claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it is individually recited herein. All methods described herein can be performed in any suitable order unless otherwise indicated herein or otherwise clearly contradicted by context. The use of any and all examples, or exemplary language (e.g., “such as”), provided herein is intended merely to better illustrate the disclosure and does not pose a limitation on the scope of the claims. No language in the specification should be construed as indicating any non-claimed element essential to the practice of the disclosure.

Unless expressly specified otherwise, the term “comprising” is used in the context of the present document to indicate that further members may optionally be present in addition to the members of the list introduced by “comprising.” It is, however, contemplated as a specific embodiment of the present disclosure that the term “comprising” encompasses the possibility of no further members being present, i.e., for the purpose of this embodiment “comprising” is to be understood as having the meaning of “consisting of” or “consisting essentially of.”

As used herein, the following terms are defined following: “Alumina” is understood to be aluminum oxide, comprising Ai₂O₃, “zirconia” is understood to be zirconium oxide, comprising ZrO₂, and “Yttria” is understood to be yttrium oxide, comprising Y₂O₃.

As used herein, the terms “semiconductor wafer,” “wafer,” “substrate,” and “wafer substrate,” are used interchangeably. A wafer or substrate used in the semiconductor device industry typically has a diameter of 200 mm, or 300 mm, or 450 mm.

As used herein, the term “sintered ceramic body” is synonymous with “multilayer sintered ceramic body”, “multilayer corrosion resistant ceramic”, “corrosion resistant body”, “sintered ceramic”, “multi-layer unitary body” and similar terms and refers to a unitary, integral sintered ceramic article formed from co-compacting more than one powder mixture by application of pressure and heat which creates a unitary, dense, multilayer sintered ceramic body. The unitary, multilayer sintered ceramic body may be machined into a unitary, multilayer sintered ceramic component useful as a chamber component in plasma processing applications. As such the multilayer sintered ceramic bodies disclosed herein are not formed by laminating preformed layers together, i.e., the multilayer sintered ceramic bodies disclosed herein are not laminates.

As used herein, the term “layer” is understood to mean a thickness of material, typically one of several. The material can be, for example, a ceramic powder, a powder mixture, a calcined powder mixture, or a sintered region or sintered portion.

As used herein, “ambient temperature” refers to a temperature range of from about 22° C. to 25° C.

Semiconductor etch and deposition reactors require reactor components having surfaces which have high resistance to corrosion and erosion by halogen containing plasmas necessary for processing. The surfaces preferably minimize release of particles from the component surface into the chamber. Additionally, chamber components must possess enough mechanical strength for handleability and use, in particular at large (>100 mm in diameter) component dimensions. The sintered ceramic bodies may be machined into sintered components and as such, must be able to be handled and machined at large dimension while providing corrosion resistance, low particle generation and high mechanical strength.

Disclosed herein is a method of polishing a surface of a polycrystalline sintered ceramic body, the method comprising the steps of: a) providing a sintered ceramic body comprising a polycrystalline material and having a density of from about 99.5% to about 99.999% of the polycrystalline material's theoretical density, wherein the sintered ceramic body has at least one surface; b) grinding the at least one surface until the surface has (i) a flatness of no more than 25 microns on average measured over four quadrants of the at least one surface at angles of 0°, 90°, 180°, and 270° as measured with a spherometer, (i) an Ra of less than 14 microinches, and (iii) an Rz of less than 160 microinches; c) after the grinding step, lapping the at least one surface with a lapping plate and a lapping media slurry; d) after lapping, successively polishing the at least one surface in a series of polishing steps until the at least one surface exhibits an Ra value of ≤2 microinches and an Rz of ≤2 microinches and an absolute value for flatness of greater than 15 microns as measured with a spherometer, wherein the polishing is performed with a device comprising a plurality of orbital sanders that vibrate elliptically each of which comprises a polishing pad to contact the at least one surface during polishing, wherein the series of polishing steps comprises: i) a first polishing step wherein the polishing pads are used with a slurry of 4 to 10-micron grit particles; and ii) a second polishing step wherein the polishing pads are used with a slurry of from 1 to 3-micron grit particles.

### The Sintered Ceramic Body

The first step of the method comprises providing a sintered ceramic body comprising a polycrystalline material and having a density of from about 99.5% to about 99.999% of the polycrystalline material's theoretical density, wherein the sintered ceramic body has at least one surface. As used herein, the term “providing” means to acquire or to start the process with a sintered ceramic body having the recited characteristics.

The sintered ceramic bodies for polishing according to the disclosed methods have a greatest dimension of greater than 100 mm such as, for example, from 100 to about 625 mm, preferably from 100 to 622 mm, preferably from 200 to about 625 mm, preferably from 300 to about 625 mm, preferably from 400 to about 625 mm, preferably from 500 to about 625 mm, preferably from 300 to 622 mm, preferably from 400 to 622 mm, and preferably from 500 to 622 mm. It is preferable that the sintered ceramic body has a surface area of greater than 400 square inches, a thickness of at least 20 mm, and is non-transparent, although it may be translucent.

In some embodiments, the sintered ceramic body comprising a polycrystalline material is a single layer sintered ceramic body and in other embodiments, the sintered ceramic body is a multilayer sintered ceramic body. Suitable single layer sintered ceramic bodies are disclosed in, for example, WO 2020/206389 (yttrium oxide), WO 2021/141676 (yttrium aluminum oxide), WO 2022/015688 (magnesium aluminate spinel), and PCT/US2021/054947 (zirconia toughened alumina), PCT/US2021/052989 (yttrium oxide), the disclosures of which are incorporated herein by reference in their entireties. Suitable multilayer sintered ceramic bodies are disclosed in, for example, PCT/US2021/054773, PCT/US2021/063973, PCT/US2021/052981 (Sintered Ceramic Body of Large Dimension and Method of Making), and WO 2021/141676 (yttrium aluminum oxide), the disclosures of which are incorporated herein by reference in their entireties. In addition to the methods disclosed in the above-referenced patent application documents, a suitable apparatus and method of making high-density, large-dimension sintered ceramic bodies for polishing according to the disclosed method are disclosed in PCT/US2021/052978 (Apparatus for Preparation of Sintered Ceramic Body of Large Dimension) and PCT/US2021/052981 (Sintered Ceramic Body of Large Dimension and Method of Making), the disclosures of which are incorporated herein by reference in their entireties.

Preparation of the sintered ceramic bodies as disclosed herein may also be achieved through use of pressure assisted sintering methods such as uniaxial hot pressing whereby the die configuration or tool set is heated by way of an externally applied heat source such as induction heating.

The polycrystalline material of the sintered ceramic body is preferably at least one selected from the group consisting of YAG, yttria, alumina, magnesium aluminate spinel, and a combination of yttria and zirconia. If a multilayer embodiment, the each later may be selected from at least one of YAG, yttria, alumina, magnesium aluminate spinel, and a combination of yttria and zirconia.

In certain embodiments, the sintered ceramic bodies as disclosed herein comprise at least one first layer having at least one polycrystalline ceramic material comprising YAG (yttrium aluminum oxide or yttrium aluminate) of formula Y₃Al₅O₁₂, having a garnet structure (with a composition comprising yttria and alumina in a ratio of about 3:5), spinel (magnesium aluminate spinel, MgAl₂O₄), and yttria and zirconia, wherein the zirconia is present in the yttria in an amount of not less than 10 mol % ZrO₂ and not greater than 25 mol % ZrO₂. It is the at least one first layer that provides the surface to be polished according to the disclosed method.

In preferred embodiments, the sintered ceramic bodies as disclosed herein comprise at least one first layer having at least one polycrystalline ceramic material comprising YAG. Thus, the surface to be polished comprises YAG.

The sintered ceramic bodies for use in the disclosed method have a density of from about 99.5% to about 99.999% such as, for example, from about 99.5 to about 99.99%, and from about 99.56% to about 99.78% of the polycrystalline material's theoretical density.

Density measurements of multilayer bodies proves challenging due to differences in the densities of the layers. Density measurements can be performed on a multilayer sintered ceramic body by sectioning a sample cut from the full thickness of the multilayer sintered body into its first and second layers and performing density measurements on the layers individually. Density measurements will now be illustrated for a two-layer sintered ceramic body comprising YAG as the thinner first layer and zirconia toughened alumina for the thicker second layer made from Example 4 of PCT/US2021/063973. Density measurements were performed in accordance with the Archimedes immersion method of ASTM B962-17, and a density of from 4.55 to 4.57 g/cc, preferably about 4.56 g/cc was measured for the polycrystalline YAG at least one first layer. Density values as reported are for an average across 5 measurements, and the standard deviation in measurements (using a known standard) was measured to be about 0.002. A commercially available, single crystal sample of bulk YAG was measured for density using the methods as disclosed herein. An Archimedes density of 4.56 g/cc across 5 measurements was obtained and this value is taken as the theoretical density of YAG as used herein. As such, the at least one first layer comprising YAG of the multilayer sintered ceramic body according to an embodiment has a theoretical density of from 99.5 to 99.999%, of the theoretical density of YAG. The at least one second layer comprising about 16% by volume of at least one of stabilized and partially stabilized zirconia (and the balance alumina) was measured for density in accordance with the Archimedes immersion method of ASTM B962-17, and a density of about 4.32 g/cc was calculated. The volumetric mixing rule as known in the art was used to calculate a theoretical density of the at least one second layer comprising alumina and about 16% by volume of at least one of stabilized and partially stabilized zirconia, and a density of from 4.31 to 4.33 g/cc, preferably about 4.32 g/cc was measured and taken as the theoretical density of the at least one second layer 102. As such, the at least one second layer 102 of the multilayer sintered ceramic body (comprising about 16% by volume of zirconia and the balance alumina) has a percent of theoretical density of from 98 to 100%, preferably from 99 to 100%, preferably from 99.5 to 100%, preferably about 100% of that of the theoretical density. The unitary, multilayer sintered ceramic body as disclosed in accordance with this embodiment has at least one first and second layers each having a percent of theoretical density (also expressed as relative density, RD) which is greater than 98%, preferably from 98 to 100%, preferably from 99 to 100%, preferably from 99.5 to 99.999%, preferably about 100% of the theoretical density of the unitary, multilayer sintered ceramic body.

The relative density (RD) for a given material is defined as the ratio of the measured density of the sample to the theoretical density for the same material, as shown in the following equation. Volumetric porosity (Vp) is calculated from density measurements as follows:

$$RD = \frac{ρ sample}{ρ theoretical} = 1 - Vp ,$$

where r sample is the measured (Archimedes) density according to ASTM B962-17, r theoretical is the theoretical density as disclosed herein, and RD is the relative fractional density. Using this calculation, volumetric porosity (Vp) levels by percent of from 0.04 to 2%, preferably from 0.04 to 1%, preferably from 0.04 to 0.8%, preferably from 0.04 to 0.6%, preferably from 0.04 to 0.5%, and preferably from 0.04 to 0.4% may be calculated from measured density values for each of the at least one first layer comprising YAG and the at least one second layer comprising alumina and about 16 volume % of partially stabilized zirconia of the multilayer ceramic sintered bodies in accordance with Example 4 of PCT/US2021/063973.

The sintered ceramic bodies disclosed above have an average density of 99.5% to 99.999% is obtainable with a variation in density of 5% or less, preferably 4% or less, preferably 3% or less, preferably 2% or less, preferably 1% or less across the greatest dimension, whereby the greatest dimension may be for example about 625 mm and less, 622 mm and less, 610 mm and less, preferably 575 mm and less, preferably 525 mm and less, preferably from 100 to 625 mm, preferably from 100 to 622 mm, preferably from 100 to 575 mm, preferably from 200 to 625 mm, preferably from 200 to 510 mm, preferably from 400 to 625 mm, preferably from 500 to 625 mm.

The high density of the sintered ceramic bodies to be polished according to the disclosed method translate into high hardness values of the surfaces which may provide resistance to the erosive effects of ion bombardment used during typical plasma processes. Erosion or spalling may result from ion bombardment of component or layer surfaces through use of inert plasma gases such as Ar. Those materials having a high value of hardness may be preferred for use as materials for components due to their enhanced hardness values providing greater resistance to ion bombardment and thereby, erosion. As such, the sintered ceramic bodies exhibit high Vickers hardness. For example, hardness measurements were performed on an exemplary sintered ceramic body comprising a YAG layer providing the surface to be polished in accordance with ASTM Standard C1327 “Standard Test Method for Vickers Indentation Hardness of Advanced Ceramics.” The test equipment used for all hardness measurements was a Wilson Micro Hardness Tester Model VH1202. Hardness values of at least 1200 HV, preferably at least 1400 HV, preferably at least 1800 HV, preferably at least 2000 HV, from 1300 to 1600 HV, from 1300 to 1500 HV, from 1300 to 1450 HV, from 1300 to 1400 HV, from 1400 to 1600 HV, from 1450 and 1600 HV, from 1450 and 1550 HV were measured for the YAG surface. Measurements performed using Vickers hardness methods as known in the art were converted to SI units of GPa. Hardness values of from 12.75 to 15.69 GPa, from 12.75 to 14.71 GPa, from 12.75 to 14.22 GPa, from 12.75 to 13.73 GPa, from 13.73 and 15.69 GPa, from 14.22 and 15.69 GPa, preferably from 14.22 and 15.20 GPa were measured. These high hardness values may contribute to enhanced resistance to ion bombardment during semiconductor etch processes and reduced erosion during use, providing extended component lifetimes when the multilayer sintered ceramic body is machined into sintered ceramic components having fine scale features.

In one embodiment, the sintered ceramic body has an average hardness of from 13.0 to 16.0 GPa as calculated from eight test repetitions using an applied load of 0.2 kgf as measured in accordance with ASTM Standard C1327. In another embodiment, the sintered ceramic body has an average hardness of about 13.5 to 15 GPa as calculated from eight test repetitions using an applied load of 0.2 kgf as measured in accordance with ASTM Standard C1327. In other embodiments, the sintered ceramic body may have an average hardness of from about 13.8 to 15.8 GPa as calculated from eight test repetitions using an applied load of 0.025 kgf.

The sintered ceramic bodies to be polished according to the method disclosed herein are translucent and are not of optical grade. In embodiments, the sintered ceramic bodies transmit light at less than 60%.

The sintered ceramic bodies to be polished according to the method disclosed herein typically have a thickness of at least 10 mm, preferably from 10 mm to 30 mm, and more preferably, from 25 mm to 28 mm.

### Grinding Step

The disclosed method comprises the step of grinding the at least one surface is performed to modify the surface of the sintered ceramic body to (1) a flatness of no more than 25 microns on average measured over four quadrants of the at least one surface at angles of 0°, 90°, 180°, and 270° as measured with a spherometer, (II) an Ra of less than 14 microinches, and (iii) an Rz of less than 160 microinches.

The function of the grinding step is to flatten the surface to be polished of the sintered ceramic body. The flatness of the surface can be measured with a spherometer such as a Mahr gauge, model Millimess 1003 spherometer available from the Mahr Group of Mahr GmbH in Gottingen Germany. The flatness is preferably measured with the spherometer across the surface or, in some embodiments, over four quadrants of the surface, at angles of 0, 90, 180 and 270 degrees, using a piano fixture having the aforementioned Mahr gauge calibrated to a master flat, such as a surface plate available from Standridge Granite Corp. of Santa Fe Springs, California.

Ra and Rz are different parameters of roughness. Ra is the average roughness of a surface. Rz is the difference between the tallest “peak” and the deepest “valley” in the surface.

Ra is the integer mean of all absolute roughness profile deviations from the centerline within the measurement length. Rz is the absolute peak to valley average of five sequential sampling lengths within the measuring length. Ra compares all dimensions and has no distinguishing value when it comes to separating rejects from suitable cylinders.

Mean roughness value Ra (DIN 4768) is the arithmetic mean from all values of the roughness profile R within the measuring distance Im. It, therefore, specifies the average deviation of this surface profile from the mean line.

Mean roughness depth Rz (DIN 4768) is the average value from the individual roughness depths of five individuals measuring distances in sequence. In other words, the calculation is from five Rt values. The deviation from the mean line, specifically focusing on the highest peak and valley.

In one embodiment, the disclosed process comprises the step of grinding the surface of the sintered ceramic body with a Blanchard machine until the ceramic surface has a flatness of no more than 25 microns measured over four quadrants of the surface, at angles of 0, 90, 180 and 270 degrees. In addition, Ra must be less than 14 microinches, and Rz should be less than 160 microinches, and more preferably less than 150 microinches.

Ra and Rz can be measured with, for example, a digital microscope, such as a Keyence VK-X200 series available from Keyence Corporation of America, Itasca, Illinois, USA.

### Lapping

The method disclosed herein comprises the step of lapping the at least one surface with a lapping plate and a lapping media slurry. Lapping is a process well-known in the art and involves contacting at least one surface of the sintered ceramic body with a surface of a lapping plate while at least one of the ceramic body and plate rotate so as to remove material from the surface of the sintered ceramic body and provide a flatter and/or smoother surface relative to before the lapping step. This includes the at least partial removal of scratches in the surface, if present. Abrasive media (e.g., diamond grit or alumina) can be used to help remove material from the surface to make it smoother. Abrasive material can be fixed to the lapping plate and/or be dispensed onto the surface of the lapping plate (e.g., as an abrasive slurry) during lapping.

The lapping step disclosed herein may comprise more than one lapping process to achieve the desired flatness and/or smoothness. In one embodiment, the lapping step comprises (i) a first lapping step wherein the lapping media is alumina having an average particle size of from 30 to 50 microns; (ii) a second lapping step wherein the lapping media is alumina having an average particle size of from 10 to 20 microns; and (iii) a third lapping step wherein the lapping media is alumina having an average particle size of from 5 to 10 microns. In another embodiment, the lapping media in the first lapping step has a particle size of 40 microns; (ii) the lapping media in the second lapping step has a particle size of 12 microns; and (ii) the lapping media in the third lapping step has a particle size of 6 microns.

Lapping is performed by mounting the sintered ceramic body on a support (platen) with the ceramic surface to be polished facing upward. A lapping plate is pressed against the ceramic surface and oscillated back and forth across the ceramic surface while the ceramic surface is rotated. The lapping is also permitted to rotate and the lapping plate and the support may rotate in the same direction or in opposite directions. With a given grit size and fluid viscosity, varying the lapping pressure produces a higher or lower material removal rate, a thicker or thinner film, and a rougher or finer surface finish. In practice, therefore, the pressure is usually light at the beginning of the process, increasing as work proceeds, and diminished towards the end. This results in the optimum material removal rate, surface finish, and flatness achieving overall surface finish quality to perfection. The waviness (also known as peaks and valleys) is a calculation of surface irregularities with a spacing greater than the surface roughness. These usually occur due to warping, vibrations, or deflection during the machining process.

Preferably, after the lapping step the surface smoothness is about 6 microinches.

### Vibrational Polishing

The disclosed method comprises the step of, after lapping, successively polishing the at least one surface in a series of polishing steps until the at least one surface exhibits an Ra value of ≤2 microinches and an Rz of ≤2 microinches and an absolute value for flatness of greater than 15 microns as measured with a spherometer, wherein the polishing is performed with a device comprising a plurality of orbital sanders that vibrate elliptically each of which comprises a polishing pad to contact the at least one surface during polishing, wherein the series of polishing steps comprises: i) a first polishing step wherein the polishing pads are used with a polishing slurry comprising from 4 to 10-micron grit particles; and i) a second polishing step wherein the polishing pads are used with a polishing slurry comprising from 1 to 3-micron grit particles.

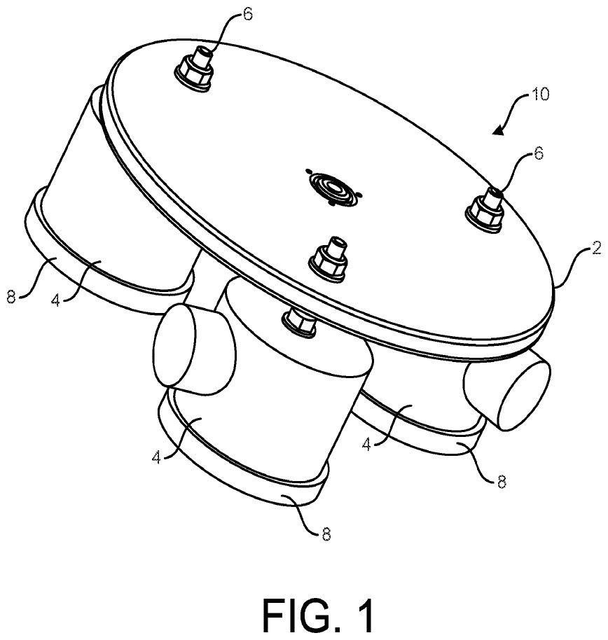

Polishing according to the disclosed method is accomplished with a device comprising a plurality of orbital sanders that vibrate elliptically each of which comprises a polishing pad to contact the at least one surface during polishing. Referring to FIG. 1, there is shown a device 10 comprising a plate 2 comprising a plurality of orbit sanders 4 (also referred to herein as “orbital sanders”) that vibrate elliptically each of which comprises a polishing pad 8. Each of the plurality of orbital sanders 4 is mounted onto the plate 2 with a screw/bolt assembly 6. Orbital sanders are known in the art and are powered by either electricity or by pneumatic pressure. Non-limiting examples of orbit sanders 4 suitable for use in the disclosed polishing method include the random orbit sanders described in U.S. Pat. Nos. 5,934,985; 5,595,531; 5,580,302; 5,411,386; 5,392,568; and 5,384,984, all of which are incorporated herein by reference in their entireties, and/or commercially available orbital sanders, such as those available from Dynabrade in Clarence, NY, USA.

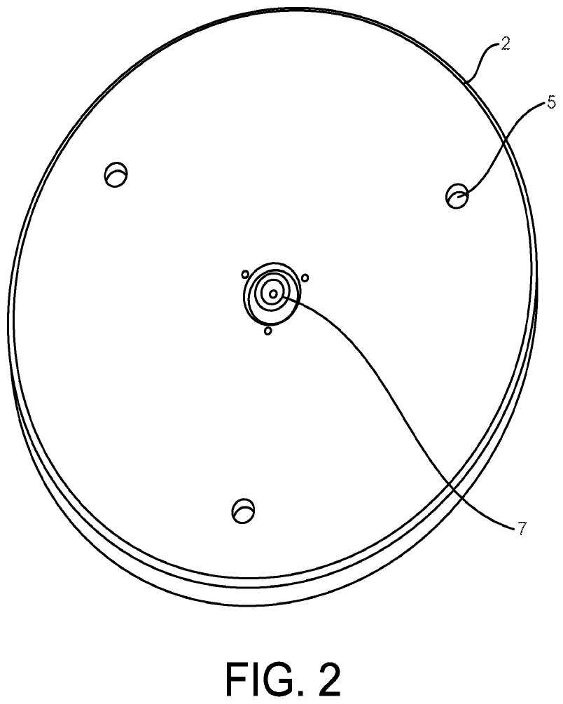

FIG. 2 illustrates the plate 2 comprising holes 5 for accepting screw/bolt assembles 6 for mounting each of the plurality of orbital sanders 4 and a mounting portion 7 for mounting plate 2 onto a device for a polishing operation. Plate 2 can be made from any durable material known in the art and suitable to withstand polishing pressures including steel. In the embodiment shown, plate 2 is round, however, it could have any shape as long as it can rotate.

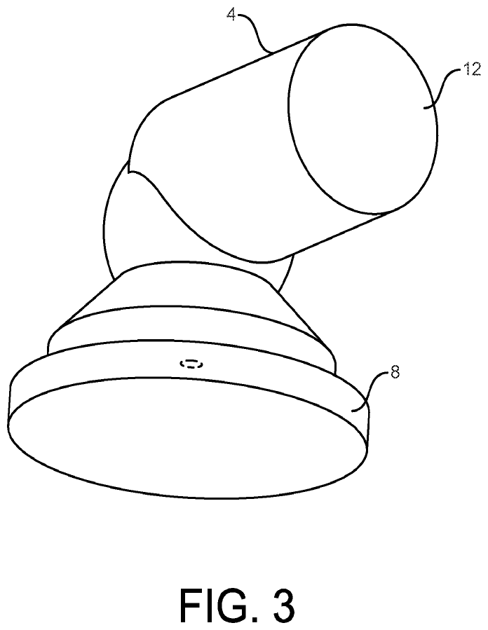

FIGS. 3 to 5 illustrate an orbital sander 4, a housing 9, and an assembled orbital sander 4 ready for mounting to plate 2, respectively. Referring to FIG. 3, a pneumatic orbital sander is shown with pneumatic opening assembly 12 comprising an air inlet and an air outlet to provide air and exhaust it as necessary. In an exemplary embodiment, compressed air at about 100 psi is used to power the orbital sanders. Not shown are the connections and hoses that lead to a pressurized air supply source.

Polishing pads 8 comprise a platen that may or may not comprise abrasive particles also referred to herein as “grit particles” for polishing at least one surface of a sintered ceramic body. In embodiments where the platen does not comprise abrasive particles incorporated therein, then an abrasive-containing slurry is applied between the sintered ceramic body and the platen for polishing. In any event, the phrase “wherein the polishing pads comprise X-micron grit particles” is intended to include the particles delivered by a liquid slurry. The platen is secured to a bearing via a plurality of threaded screws which extend through openings in the platen. The bearing is disposed eccentrically to a drive spindle of the motor which, thus, imparts an orbital motion to the platen as the platen is driven rotationally by the motor. The platen can be any size needed such as, for example, a diameter of from 80 mm to 300 mm. In one embodiment, the platen is 6 inches (152.4 mm).

In some embodiments, the polishing pads 8 are unfilled micro-cellular foam elastomer pads, such as polyurethane pads commercially available from Universal Photonics Incorporated (https://www.universalphotonics.com/UPIProducts/Consumables/tabid/102/prtype/1105/prid/490/Default.aspx) of Central Islip, NY, USA

Slurries suitable for use in the polishing step of the disclosed method include abrasive particles of the desired size as well as a liquid delivery vehicle such as, for example, water. The slurries may comprise other components typically found in such slurries such as, for example, lubricants. The abrasive (grit) particles should be harder than the surface to be polished and can be selected, for example, from polycrystalline diamond particles and aluminum oxide particles. Preferably, the abrasive particles for the polishing step are polycrystalline diamond particles in an aqueous suspension.

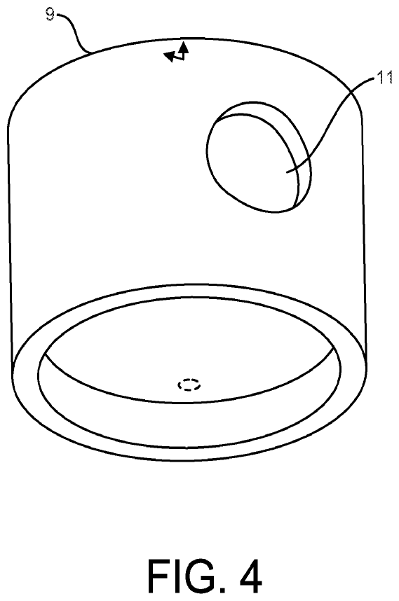

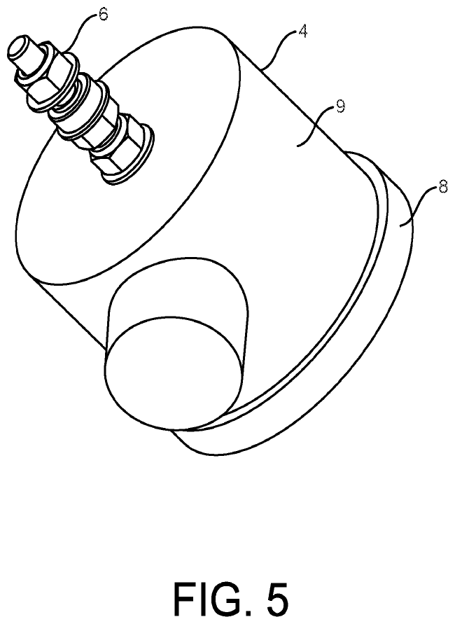

Referring to FIG. 4, housing 9 has an opening 11 to receive air supply hoses if a pneumatic motor is used or an electrical connection if an electrical motor is used. FIG. 5 shows the assembled orbit sander fit with a screw/bolt assembly ready to be mounted on plate 2. Orbital sanders 4 can be mounted on plate 2 in any suitable configuration.

Orbital sanders 4 typically exhibit speeds of from 5,000 to 15,000 RPM. In some embodiments, the orbital sanders exhibit speeds of from 10,000 to 15,000 RPM and, in preferred embodiments, 12,000 RPM (maximum). Such speeds are capable of providing high shear rate to the polishing. In some embodiments when a slurry is employed, the shear rate of the slurry against the sintered ceramic body is from about 1 to about 10 m/s and, preferably, about 6 m/s.

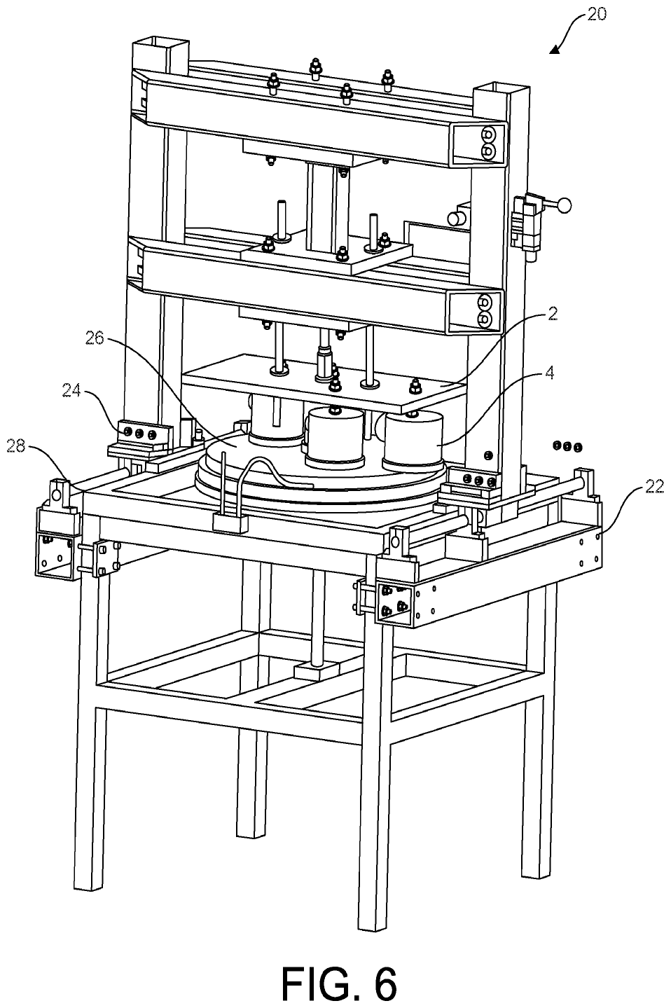

FIG. 6 shows an exemplary polishing apparatus 20 for use in the polishing step of the disclosed method. Plate 2 is fixed and a rotatable table 22 suitable for rotating a part 24 having a surface 26 to be polished by a slurry delivered by slurry delivery apparatus 28. In the embodiment shown, there are four orbital sanders 4, however, in other embodiments, there may be two or three or five. The orbit sanders 4 are mounted on the plate 2 such that the polishing pads face the rotatable table and, thus, the sintered ceramic body secured on the table. During the polishing step, the at least one surface of the sintered ceramic body is rotated and the orbital sanders are stationary in the embodiment shown. An exemplary polishing apparatus as shown in FIG. 6.

The polishing step is preferably performed in a number of sequential sub steps, each using a reduced particle size of the grit relative to the step before. In one embodiment, the series of polishing steps comprises: i) a first polishing step wherein the polishing pads comprise from 4 to 10-micron grit particles; and ii) a second polishing step wherein the polishing pads comprise from 1 to 3-micron grit particles. In one embodiment, a 6-micron grit slurry is used for the first polishing step and a 2-micron grit slurry is used for the second polishing step. In another embodiment, a 6-micron grit slurry is used for the first polishing step and a 1-micron grit slurry is used for the second polishing step. Typically, the pressure on the surface of sintered ceramic body during the polishing step(s) is from 0.2 to 2 psi, more preferably from 0.3 to 1 psi, and the RPM of the rotating table is preferably from 100 to 200 RPM, more preferably from 130 to 160, and even more preferably from 140 to 150 RPM.

After performance of the method disclosed herein, the porosity of the polished surface is preferably less than 0.045% over the surface area polished as measured from SEM images and using ImageJ software. Typically, measurements across 7 SEM images are made. In some embodiments, porosity in a percent of total area is exhibited in an amount of from 0.0005 to 0.045% as measured from SEM images and using ImageJ software. Thus, for example, across an image of area about 54 μm×54 μm, the polished surface of the sintered ceramic bodies as disclosed herein comprise a porosity in very low (<0.045% by total area) percentages, thus providing a corrosion and erosion resistant surface for use in plasma processing chambers.

The disclosed method produces a polycrystalline sintered ceramic body having at least one upper surface having a surface area of greater than 400 square inches, the surface having a spherometer measurement with an absolute value greater than 15 microns over four quadrants of the disk, and Ra and Rz each less than or equal to 2 microinches over the surface area, and a porosity of less than 0.045% over the surface area, wherein the sintered ceramic disk has a thickness of at least 20 mm.

In one embodiment wherein the sintered ceramic body comprises YAG, the disclosed method produces a polycrystalline sintered ceramic body comprising at least 99.99% YAG and having at least one upper surface having a surface area of greater than 400 square inches, the surface having a spherometer measurement with an absolute value greater than 15 microns over four quadrants of the disk, and Ra and Rz each less than or equal to 2 microinches over the surface area, and a porosity of less than 0.045% over the surface area, wherein the sintered ceramic disk has a thickness of at least 20 mm.

One advantage of the disclosed method is that grain pullout is prevented. Grain pullout is the dislodging of grains on the surface to create pits thus causing a significant deviation in surface smoothness that can be readily attacked by plasma etch gases.

### Examples

A 24-inch disc having a 99.99% YAG surface was obtained having a YAG density averaging at least 99.5% of the maximum theoretical density for YAG. This 24-inch disc when lapped and polished as described herein resulted in average final Ra, Rz and RSm values as shown in the following table:

| Measurement | | | |
|---|---|---|---|
| Direction | Ra (microns) | Rz (microns) | RSm (microns) |
| Vertically across the | 0.0191 | .1495 | 5.1144 |
| disc | | | |
| Horizontally across | 0.0181 | .1405 | 6.918 |
| the disc | | | |

For comparison, a 22-inch diameter example disc was prepared of 99.99% YAG, but having an average density of only about 97% of the maximum theoretical density for YAG. Lapping and polishing this example disc as described previously resulted in average final Ra, Rz and RSm values as shown in the table below:

| Measurement | | | |
|---|---|---|---|
| Direction | Ra (microns) | Rz (microns) | RSm (microns) |
| Vertically across the | 0.025 | .212 | 5.742 |
| disc | | | |
| Horizontally across | 0.028 | .275 | 10.533 |
| the disc | | | |

As can be seen by comparing the values in the two tables above, the comparison 22-inch diameter example disc had a significantly rougher surface. Since the lapping and polishing steps were the same for both discs, this is believed to be due to the difference in average density of the YAG surfaces that were polished on the discs. In particular, the disc with the lower density surface, resulted in greater surface roughness compared to the disc with greater density.

A number of embodiments have been described as disclosed herein. Nevertheless, it will be understood that various modifications may be made without departing from the spirit and scope of the embodiments as disclosed herein. Accordingly, other embodiments are within the scope of the following claims.

1-18. (canceled)

19. A method of polishing a surface of a polycrystalline sintered ceramic body, the method comprising the steps of:
a. providing a sintered ceramic body comprising a polycrystalline material and having a density of from about 99.5% to about 99.999% of the polycrystalline material's theoretical density, wherein the sintered ceramic body has at least one surface;
b. grinding the at least one surface until the surface has (i) a flatness of no more than 25 microns on average measured over four quadrants of the at least one surface at angles of 0°, 90°, 180°, and 270° as measured with a spherometer, (ii) an Ra of less than 0.3556 μm (14 microinches), and (iii) an Rz of less than 4.064 μm (160 microinches), whereby Ra means the average roughness of a surface as an integer mean of all absolute roughness profile deviations from the centerline within the measurement length and Rz means the difference between the tallest peak and the deepest valley in the surface as an absolute peak to valley average of five sequential sampling lengths within the measuring length;
c. after the grinding step, lapping the at least one surface with a lapping plate and a lapping media slurry;
d. after lapping, successively polishing the at least one surface in a series of polishing steps until the at least one surface exhibits an Ra value of ≤0.0508 μm (2 microinches) and an Rz of ≤0.0508 μm (2 microinches) and an absolute value for flatness of greater than 15 microns as measured with a spherometer, wherein the polishing is performed with a device comprising a plurality of orbital sanders that vibrate elliptically each of which comprises a polishing pad to contact the at least one surface during polishing,
wherein the series of polishing steps comprises:
i. a first polishing step wherein the polishing pads are used with a slurry of 4 to 10-micron grit particles; and
ii. a second polishing step wherein the polishing pads are used with a slurry of from 1 to 3-micron grit particles.

20. The method of claim 19 wherein the lapping step comprises (i) a first lapping step wherein the lapping media is alumina having an average particle size of from 30 to 50 microns; (ii) a second lapping step wherein the lapping media is alumina having an average particle size of from 10 to 20 microns; and (iii) a third lapping step wherein the lapping media is alumina having an average particle size of from 5 to 10 microns.

21. The method of claim 20 wherein the lapping media in the first lapping step has a particle size of 40 microns; (ii) the lapping media in the second lapping step has a particle size of 12 microns; and (iii) the lapping media in the third lapping step has a particle size of 6 microns.

22. The method of claim 19 wherein the polycrystalline material is selected from the group consisting of YAG, yttria, alumina, magnesium aluminate spinel, and a combination of yttria and zirconia.

23. The method of claim 19 wherein the grit particles of the first polishing step are 6 microns and the grit particles of the second polishing step are 2 microns.

24. The method of claim 19 wherein the grit particles of the first polishing step are 6 microns and the grit particles of the second polishing step are 1 micron.

25. The method of claim 19 wherein the Ra after the polishing step is less than 0.0381 μm (1.5 microinches).

26. The method of claim 19 wherein, during the polishing step, the at least one surface is rotated and the orbital sanders are stationary.

27. The method of claim 19 wherein the polycrystalline material is YAG.

28. The method of claim 27 wherein the density of the sintered ceramic body is from about 99.56% to about 99.78% of the theoretical density of YAG.

29. The method of claim 19 wherein the polycrystalline sintered ceramic body has a diameter of from about 100 mm to about 625 mm.

30. The method of claim 19 wherein the sanding pads rotate in an elliptical orbit at a rate of up to 12,000 RPM, resulting in a sheer velocity of 0.5 m/s to 5.0 m/s on the at least one surface.

31. The method of claim 19 wherein the plurality of orbital sanders is selected from three and four.

32. The method of claim 31 wherein the plurality of orbital sanders is three.

33. The method of claim 31 wherein the plurality of orbital sanders is four.

34. The method of claim 19 wherein the sintered ceramic body comprising a polycrystalline material has an average hardness of from 13.0 to 16.0 GPa as calculated from eight test repetitions using an applied load of 0.2 kgf as measured in accordance with ASTM Standard C1327.

35. A polycrystalline sintered ceramic body comprising at least 99.99% YAG and having at least one upper surface having a surface area of greater than 0.2580 m² (400 square inches), the surface having a spherometer measurement with an absolute value greater than 15 microns over four quadrants of the disk, and Ra and Rz each less than or equal to 2 microinches over the surface area, and a porosity of less than 0.045% over the surface area, wherein the sintered ceramic disk has a thickness of at least 20 mm.
